(19) United States
(12) Patent Application Publication
(10) Pub. No.: US 2020/0192364 A1
(43) Pub. Date: Jun. 18, 2020

(54) SYSTEM AND METHOD FOR CONTROL OF AN AUTONOMOUS VEHICLE

(71) Applicant: GM GLOBAL TECHNOLOGY OPERATIONS LLC, DETROIT, MI (US)

(72) Inventors: Eric L. Raphael, Birmingham, MI (US); Raymond J. Kiefer, Huntington Woods, MI (US); Samuel T. Haberl, Ann Arbor, MI (US)

(21) Appl. No.: 16/218,601

(22) Filed: Dec. 13, 2018

(51) Int. Cl. G05D 1/00; G05D 1/02; B60W 30/09; B60W 30/095

(52) U.S. Cl. CPC G05D 1/0088; G05D 1/0214; B60W 2550/30; B60W 30/0956; G05D 2201/0213; B60W 30/09

(57) ABSTRACT

An automotive vehicle includes at least one actuator configured to control vehicle steering, acceleration, braking, or shifting, at least sensor configured to provide signals based on features in the vicinity of the vehicle, and a controller configured to control the at least one actuator in an automated driving mode. The controller is configured to detect behavior of at least one object external to the vehicle based on signals from the at least one sensor. The controller is additionally configured to determine, based on the detected behavior, that the at least one object is influencing lateral or longitudinal motion of the vehicle. The controller is also configured to determine, based on signals from the at least one sensor, that no driving condition is present to necessitate the behavior of the at least one object. The controller is further configured to, in response to the determinations, activate a swarm defense mode.

### INTRODUCTION

The present disclosure relates to vehicles controlled by automated driving systems, particularly those configured to automatically control vehicle steering, acceleration, and braking during a drive cycle without human intervention.

The operation of modern vehicles is becoming more automated, i.e. able to provide driving control with less and less driver intervention. Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

### SUMMARY

An automotive vehicle according to the present disclosure includes at least one actuator configured to control vehicle steering, acceleration, braking, or shifting. The vehicle additionally includes at least sensor configured to provide signals based on features in the vicinity of the vehicle. The vehicle further includes a controller configured to control the at least one actuator in an automated driving mode. The controller is configured to detect behavior of at least one object external to the vehicle based on signals from the at least one sensor. The controller is additionally configured to determine, based on the detected behavior, that the at least one object is influencing lateral or longitudinal motion of the vehicle. The controller is also configured to determine, based on signals from the at least one sensor, that no driving condition is present to necessitate the behavior of the at least one object. The controller is further configured to, in response to the determinations, activate a swarm defense mode.

In an exemplary embodiment, the at least one object external to the vehicle includes one or more target vehicles proximate the vehicle.

In various exemplary embodiments, the swarm defense mode includes communicating an alert to an external authority entity and/or controlling the at least one actuator to drive the vehicle on a restricted driving surface.

In an exemplary embodiment, influencing lateral or longitudinal motion of the vehicle includes bringing the vehicle to a full stop.

In an exemplary embodiment, the controller is further configured to detect a change in vehicle state based on signals from the at least one sensor, and to activate the swarm defense mode in further response to a detected change in vehicle state. In such embodiments, the change in vehicle state may include a change in passenger weight, a sensor being blocked, a window being broken, or a rapid decrease in tire pressure.

A method of controlling an automotive vehicle according to the present disclosure includes providing the vehicle with at least one actuator configured to control vehicle steering, acceleration, braking, or shifting, at least sensor configured to provide signals based on features in the vicinity of the vehicle, and a controller configured to control the at least one actuator in an automated driving mode. The method also includes detecting, via the controller, behavior of at least one object external to the vehicle based on signals from the at least one sensor. The method additionally includes determining, via the controller, based on the detected behavior, that the at least one object is influencing lateral or longitudinal motion of the vehicle. The method further includes determining, via the controller, based on signals from the at least one sensor, that no driving condition is present to necessitate the behavior of the at least one object. The method still further includes, in response to the determining steps, automatically controlling the vehicle, via the controller, according to a swarm defense mode.

In an exemplary embodiment, the at least one object external to the vehicle includes one or more target vehicles proximate the vehicle.

According to various exemplary embodiments, automatically controlling the vehicle according to the swarm defense mode includes communicating an alert to an external authority entity and/or automatically controlling the at least one actuator to drive the vehicle on a restricted driving surface.

In an exemplary embodiment, influencing lateral or longitudinal motion of the vehicle includes bringing the vehicle to a full stop.

In an exemplary embodiment, the method additionally includes detecting, via the controller, a change in vehicle state based on signals from the at least one sensor. In such embodiments, automatically controlling the vehicle according to the swarm defense mode is in further response to detecting the change in vehicle state. The change in vehicle state may include a change in passenger weight, a sensor being blocked, a window being broken, or a rapid decrease in tire pressure.

Embodiments according to the present disclosure provide a number of advantages. For example, the present disclosure provides a system and method for detecting swarm behavior proximate an autonomous vehicle, and to respond appropriately when such behavior is detected.

The above and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic diagram of a communication system including an autonomously controlled vehicle according to an embodiment of the present disclosure;

FIG. 2 is a schematic block diagram of an automated driving system (ADS) for a vehicle according to an embodiment of the present disclosure; and

FIG. 3 is a flowchart representation of a method of controlling a vehicle according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

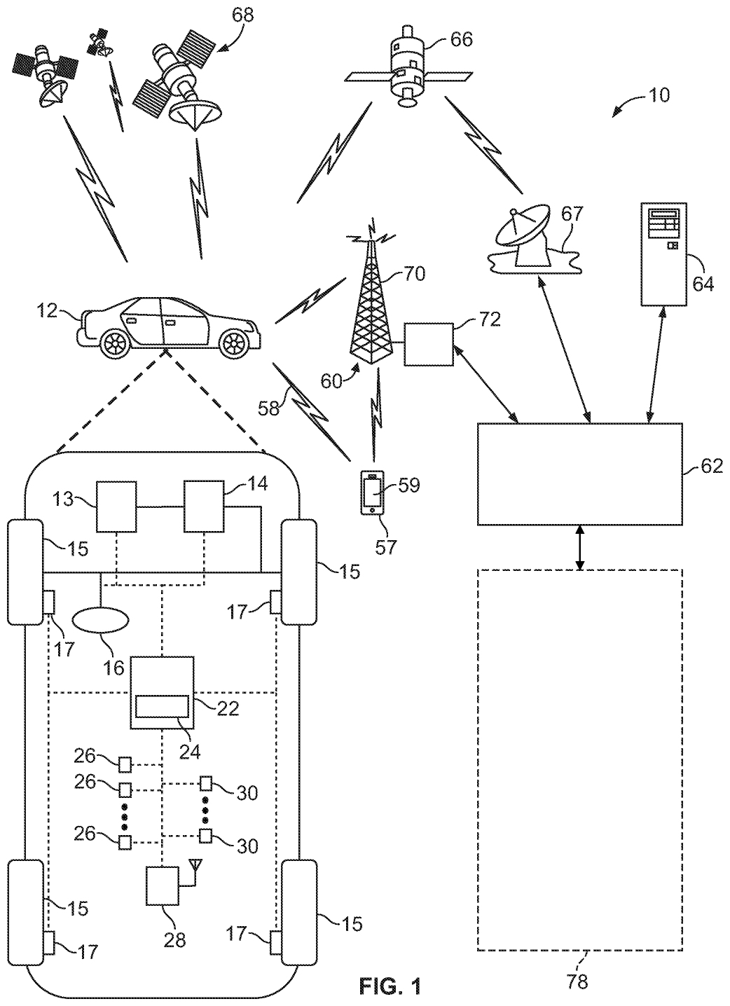

FIG. 1 schematically illustrates an operating environment that comprises a mobile vehicle communication and control system 10 for a motor vehicle 12. The motor vehicle 12 may be referred to as a host vehicle. The communication and control system 10 for the host vehicle 12 generally includes one or more wireless carrier systems 60, a land communications network 62, a computer 64, a mobile device 57 such as a smart phone, and a remote access center 78.

The host vehicle 12, shown schematically in FIG. 1, is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. The host vehicle 12 includes a propulsion system 13, which may in various embodiments include an internal combustion engine, an electric machine such as a traction motor, and/or a fuel cell propulsion system.

The host vehicle 12 also includes a transmission 14 configured to transmit power from the propulsion system 13 to a plurality of vehicle wheels 15 according to selectable speed ratios. According to various embodiments, the transmission 14 may include a step-ratio automatic transmission, a continuously-variable transmission, or other appropriate transmission. The host vehicle 12 additionally includes wheel brakes 17 configured to provide braking torque to the vehicle wheels 15. The wheel brakes 17 may, in various embodiments, include friction brakes, a regenerative braking system such as an electric machine, and/or other appropriate braking systems.

The host vehicle 12 additionally includes a steering system 16. While depicted as including a steering wheel for illustrative purposes, in some embodiments contemplated within the scope of the present disclosure, the steering system 16 may not include a steering wheel.

The host vehicle 12 includes a wireless communications system 28 configured to wirelessly communicate with other vehicles (“V2V”) and/or infrastructure (“V2I”). In an exemplary embodiment, the wireless communication system 28 is configured to communicate via a dedicated short-range communications (DSRC) channel. DSRC channels refer to one-way or two-way short-range to medium-range wireless communication channels specifically designed for automotive use and a corresponding set of protocols and standards. However, wireless communications systems configured to communicate via additional or alternate wireless communications standards, such as IEEE 802.11 (“WiFi™”) and cellular data communication, are also considered within the scope of the present disclosure.

The propulsion system 13, transmission 14, steering system 16, and wheel brakes 17 are in communication with or under the control of at least one controller 22. While depicted as a single unit for illustrative purposes, the controller 22 may additionally include one or more other controllers, collectively referred to as a “controller.” The controller 22 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

The controller 22 includes an automated driving system (ADS) 24 for automatically controlling various actuators in the vehicle. In an exemplary embodiment, the ADS 24 is a so-called Level Four or Level Five automation system. A Level Four system indicates “high automation”, referring to the driving mode-specific (e.g. within defined geographic boundaries) performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

Other embodiments according to the present disclosure may be implemented in conjunction with so-called Level One, Level Two, or Level Three automation systems. A Level One system indicates “driver assistance”, referring to the driving mode-specific execution by a driver assistance system of either steering or acceleration using information about the driving environment and with the expectation that the human driver performs all remaining aspects of the dynamic driving task. A Level Two system indicates “Partial Automation”, referring to the driving mode-specific execution by one or more driver assistance systems of both steering and acceleration using information about the driving environment and with the expectation that the human driver performs all remaining aspects of the dynamic driving task. A Level Three system indicates “Conditional Automation”, referring to the driving mode-specific performance by an automated driving system of all aspects of the dynamic driving task with the expectation that the human driver will respond appropriately to a request to intervene.

In an exemplary embodiment, the ADS 24 is configured to control the propulsion system 13, transmission 14, steering system 16, and wheel brakes 17 to control vehicle acceleration, steering, and braking, respectively, without human intervention via a plurality of actuators 30 in response to inputs from a plurality of sensors 26, which may include GPS, RADAR, LIDAR, optical cameras, thermal cameras, ultrasonic sensors, and/or additional sensors as appropriate.

FIG. 1 illustrates several networked devices that can communicate with the wireless communication system 28 of the host vehicle 12. One of the networked devices that can communicate with the host vehicle 12 via the wireless communication system 28 is the mobile device 57. The mobile device 57 can include computer processing capability, a transceiver capable of communicating signals 58 using a short-range wireless protocol, and a visual smart phone display 59. The computer processing capability includes a microprocessor in the form of a programmable device that includes one or more instructions stored in an internal memory structure and applied to receive binary input to create binary output. In some embodiments, the mobile device 57 includes a GPS module capable of receiving signals from GPS satellites 68 and generating GPS coordinates based on those signals. In other embodiments, the mobile device 57 includes cellular communications functionality such that the mobile device 57 carries out voice and/or data communications over the wireless carrier system 60 using one or more cellular communications protocols, as are discussed herein. The mobile device 57 may also include other sensors, including but not limited to, accelerometers capable of measuring motion of the mobile device 57 along six axes. The visual smart phone display 59 may also include a touch-screen graphical user interface.

The wireless carrier system 60 is preferably a cellular telephone system that includes a plurality of cell towers 70 (only one shown), one or more mobile switching centers (MSCs) 72, as well as any other networking components required to connect the wireless carrier system 60 with the land communications network 62. Each cell tower 70 includes sending and receiving antennas and a base station, with the base stations from different cell towers being connected to the MSC 72 either directly or via intermediary equipment such as a base station controller. The wireless carrier system 60 can implement any suitable communications technology, including for example, analog technologies such as AMPS, or digital technologies such as CDMA (e.g., CDMA2000) or GSM/GPRS. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from using the wireless carrier system 60, a second wireless carrier system in the form of satellite communication can be used to provide unidirectional or bidirectional communication with the host vehicle 12. This can be done using one or more communication satellites 66 and an uplink transmitting station 67. Unidirectional communication can include, for example, satellite radio services, wherein programming content (news, music, etc.) is received by the transmitting station 67, packaged for upload, and then sent to the satellite 66, which broadcasts the programming to subscribers. Bidirectional communication can include, for example, satellite telephony services using the satellite 66 to relay telephone communications between the host vehicle 12 and the station 67. The satellite telephony can be utilized either in addition to or in lieu of the wireless carrier system 60.

The land network 62 may be a conventional land-based telecommunications network connected to one or more landline telephones and connects the wireless carrier system 60 to the remote access center 78. For example, the land network 62 may include a public switched telephone network (PSTN) such as that used to provide hardwired telephony, packet-switched data communications, and the Internet infrastructure. One or more segments of the land network 62 could be implemented through the use of a standard wired network, a fiber or other optical network, a cable network, power lines, other wireless networks such as wireless local area networks (WLANs), or networks providing broadband wireless access (BWA), or any combination thereof. Furthermore, the remote access center 78 need not be connected via land network 62, but could include wireless telephony equipment so that it can communicate directly with a wireless network, such as the wireless carrier system 60.

While shown in FIG. 1 as a single device, the computer 64 may include a number of computers accessible via a private or public network such as the Internet. Each computer 64 can be used for one or more purposes. In an exemplary embodiment, the computer 64 may be configured as a web server accessible by the host vehicle 12 via the wireless communication system 28 and the wireless carrier 60. Other computers 64 can include, for example: a service center computer where diagnostic information and other vehicle data can be uploaded from the vehicle via the wireless communication system 28 or a third party repository to or from which vehicle data or other information is provided, whether by communicating with the host vehicle 12, the remote access center 78, the mobile device 57, or some combination of these. The computer 64 can maintain a searchable database and database management system that permits entry, removal, and modification of data as well as the receipt of requests to locate data within the database. The computer 64 can also be used for providing Internet connectivity such as DNS services or as a network address server that uses DHCP or other suitable protocol to assign an IP address to the host vehicle 12. The computer 64 may be in communication with at least one supplemental vehicle in addition to the host vehicle 12. The host vehicle 12 and any supplemental vehicles may be collectively referred to as a fleet. In an exemplary embodiment, the computer 64 is configured to store, e.g. in non-transient data memory, subscriber account information and/or vehicle information. The subscriber account information can include, but is not limited to, biometric data, password information, subscriber preferences, and learned behavioral patterns of users or occupants of vehicles in the fleet. The vehicle information can include, but is not limited to, vehicle attributes such as color, make, model, license plate number, notification light pattern, and/or frequency identifiers.

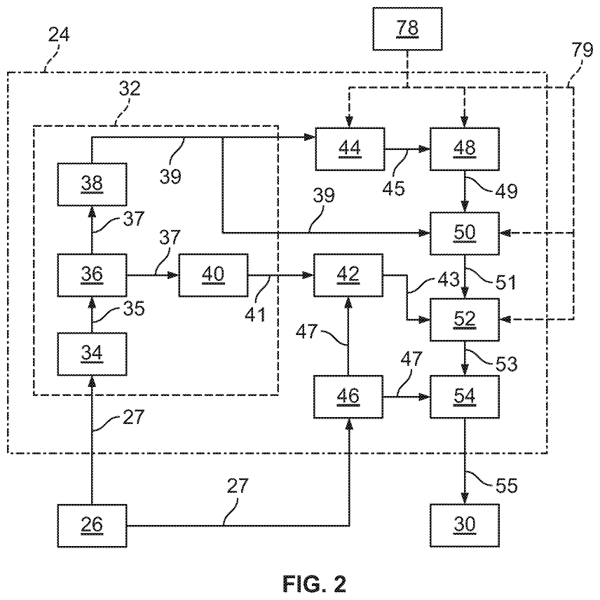

As shown in FIG. 2, the ADS 24 includes multiple distinct systems, including at least a perception system 32 for determining the presence, location, classification, and path of detected features or objects in the vicinity of the vehicle. The perception system 32 is configured to receive inputs from a variety of sensors, such as the sensors 26 illustrated in FIG. 1, and synthesize and process the sensor inputs to generate parameters used as inputs for other control algorithms of the ADS 24.

The perception system 32 includes a sensor fusion and preprocessing module 34 that processes and synthesizes sensor data 27 from the variety of sensors 26. The sensor fusion and preprocessing module 34 performs calibration of the sensor data 27, including, but not limited to, LIDAR to LIDAR calibration, camera to LIDAR calibration, LIDAR to chassis calibration, and LIDAR beam intensity calibration. The sensor fusion and preprocessing module 34 outputs preprocessed sensor output 35.

A classification and segmentation module 36 receives the preprocessed sensor output 35 and performs object classification, image classification, traffic light and sign classification, object segmentation, ground segmentation, and object tracking processes. Object classification includes, but is not limited to, identifying and classifying objects in the surrounding environment including identification and classification of traffic signals and signs, RADAR fusion and tracking to account for the sensor's placement and field of view (FOV), and false positive rejection via LIDAR fusion to eliminate the many false positives that exist in an urban environment, such as, for example, manhole covers, bridges, overhead trees or light poles, and other obstacles with a high RADAR cross section but which do not affect the ability of the vehicle to travel along its path. Additional object classification and tracking processes performed by the classification and segmentation model 36 include, but are not limited to, freespace detection and high level tracking that fuses data from RADAR tracks, LIDAR segmentation, LIDAR classification, image classification, object shape fit models, semantic information, motion prediction, raster maps, static obstacle maps, and other sources to produce high quality object tracks. The classification and segmentation module 36 additionally performs traffic control device classification and traffic control device fusion with lane association and traffic control device behavior models. The classification and segmentation module 36 generates an object classification and segmentation output 37 that includes object identification information.

A localization and mapping module 40 uses the object classification and segmentation output 37 to calculate parameters including, but not limited to, estimates of the position and orientation of the host vehicle 12 in both typical and challenging driving scenarios. These challenging driving scenarios include, but are not limited to, dynamic environments with many cars (e.g., dense traffic), environments with large scale obstructions (e.g., roadwork or construction sites), hills, multi-lane roads, single lane roads, a variety of road markings and buildings or lack thereof (e.g., residential vs. business districts), and bridges and overpasses (both above and below a current road segment of the vehicle).

The localization and mapping module 40 also incorporates new data collected as a result of expanded map areas obtained via onboard mapping functions performed by the host vehicle 12 during operation and mapping data “pushed” to the host vehicle 12 via the wireless communication system 28. The localization and mapping module 40 updates previous map data with the new information (e.g., new lane markings, new building structures, addition or removal of constructions zones, etc.) while leaving unaffected map regions unmodified. Examples of map data that may be generated or updated include, but are not limited to, yield line categorization, lane boundary generation, lane connection, classification of minor and major roads, classification of left and right turns, and intersection lane creation. The localization and mapping module 40 generates a localization and mapping output 41 that includes the position and orientation of the host vehicle 12 with respect to detected obstacles and road features.

A vehicle odometry module 46 receives data 27 from the vehicle sensors 26 and generates a vehicle odometry output 47 which includes, for example, vehicle heading and velocity information. An absolute positioning module 42 receives the localization and mapping output 41 and the vehicle odometry information 47 and generates a vehicle location output 43 that is used in separate calculations as discussed below.

An object prediction module 38 uses the object classification and segmentation output 37 to generate parameters including, but not limited to, a location of a detected obstacle relative to the vehicle, a predicted path of the detected obstacle relative to the vehicle, and a location and orientation of traffic lanes relative to the vehicle. Data on the predicted path of objects (including pedestrians, surrounding vehicles, and other moving objects) is output as an object prediction output 39 and is used in separate calculations as discussed below.

The ADS 24 also includes an observation module 44 and an interpretation module 48. The observation module 44 generates an observation output 45 received by the interpretation module 48. The observation module 44 and the interpretation module 48 allow access by the remote access center 78. The interpretation module 48 generates an interpreted output 49 that includes additional input provided by the remote access center 78, if any.

A path planning module 50 processes and synthesizes the object prediction output 39, the interpreted output 49, and additional routing information 79 received from an online database or the remote access center 78 to determine a vehicle path to be followed to maintain the vehicle on the desired route while obeying traffic laws and avoiding any detected obstacles. The path planning module 50 employs algorithms configured to avoid any detected obstacles in the vicinity of the vehicle, maintain the vehicle in a current traffic lane, and maintain the vehicle on the desired route. The path planning module 50 outputs the vehicle path information as path planning output 51. The path planning output 51 includes a commanded vehicle path based on the vehicle route, vehicle location relative to the route, location and orientation of traffic lanes, and the presence and path of any detected obstacles.

A first control module 52 processes and synthesizes the path planning output 51 and the vehicle location output 43 to generate a first control output 53. The first control module 52 also incorporates the routing information 79 provided by the remote access center 78 in the case of a remote take-over mode of operation of the vehicle.

A vehicle control module 54 receives the first control output 53 as well as velocity and heading information 47 received from vehicle odometry 46 and generates vehicle control output 55. The vehicle control output 55 includes a set of actuator commands to achieve the commanded path from the vehicle control module 54, including, but not limited to, a steering command, a shift command, a throttle command, and a brake command.

The vehicle control output 55 is communicated to actuators 30. In an exemplary embodiment, the actuators 30 include a steering control, a shifter control, a throttle control, and a brake control. The steering control may, for example, control a steering system 16 as illustrated in FIG. 1. The shifter control may, for example, control a transmission 14 as illustrated in FIG. 1. The throttle control may, for example, control a propulsion system 13 as illustrated in FIG. 1. The brake control may, for example, control wheel brakes 17 as illustrated in FIG. 1.

While autonomous vehicles provide various advantages, they may be susceptible to so-called “swarming” behavior. Swarming refers to the act of maneuvering or positioning one or more vehicles or other object in a coordinated manner to influence the behavior of a target, e.g. to trap the target in a confined location. Such behavior could be performed by persons intending to cause harm to the swarmed vehicle, steal cargo or other objects located within the vehicle, or otherwise perform malicious activity. Because automated driving systems are generally configured to avoid contacting objects, including other vehicles, they may be susceptible to swarming attacks. As such, it is desirable to detect when a swarming attack is underway and to develop a strategy to respond to such attacks.

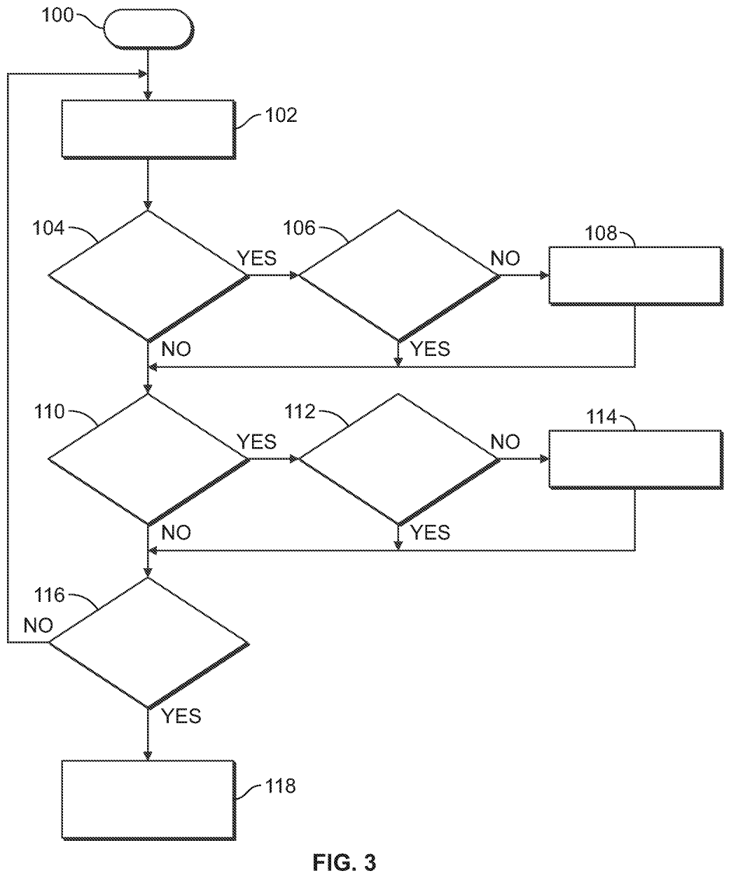

Referring now to FIG. 3, a method of controlling a vehicle according to the present disclosure is illustrated in flowchart form. While the method will be discussed with continuing reference to FIGS. 1 and 2, one of ordinary skill in the art will appreciate that the method may be performed in conjunction with vehicles arranged other than as specifically illustrated in these Figures. The algorithm begins at block 100.

Signals are received from a plurality of sensors, as illustrated at block 102. The signals may be received from a combination of on-board sensors, e.g. the sensors 26 illustrated in FIG. 1, and remote sensors, e.g. infrastructure sensors such as traffic cameras, weather sensors, or sensors disposed on other vehicles. In such embodiments, the remote sensor information may be communicated via the wireless communication system 28. In an exemplary embodiment, the signals indicate relative positions, velocities, and acceleration of objects in the vicinity of the host vehicle 12. Additionally, the signals may indicate the status of various vehicle conditions, such as tire pressure and cabin cargo weight. Furthermore, the signals may indicate current weather conditions, traffic data for the vicinity of the host vehicle 12, and information relating to other road conditions such as construction or debris in the road.

A determination is made of whether one or more objects, external to the host vehicle 12, are influencing motion of the host vehicle 12. Objects external to the host vehicle 12 may include other vehicles, which may be referred to as target vehicles, or stationary objects such as barriers. Influencing motion may refer to various actions which cause the ADS 24 to deviate from a desired route, whether such behavior results in a full stop of the host vehicle 12, a deceleration of the host vehicle 12, or an unanticipated change in route of the host vehicle 12. Such actions include, but are not limited to, an object being positioned to the fore of the host vehicle 12 to limit longitudinal travel of the host vehicle 12, or to a side of the host vehicle 12 to limit lateral travel of the host vehicle 12. Moreover, the determination may be influenced by the severity of the action. As examples, actions which may be considered more severe include a quick cut-in from a leading vehicle, physical contact between a target vehicle and the host vehicle 12, or a vehicle to the fore of the host vehicle 12 being shifted into reverse to close the gap therebetween. Furthermore, the determination may be influenced by the number and degree of coordination of the objects external to the vehicle. Degree of coordination refers to the extent to which multiple objects are influencing motion of the host vehicle 12 simultaneously.

In response to the determination of operation 104 being positive, i.e. one or more objects are influencing the motion of the host vehicle 12, a determination is made of whether the cause for the behavior of the one or more objects can be determined, as illustrated at operation 106. This determination may be based on information relating to road conditions, including traffic, construction, or other conditions as discussed above. As an example, if heavy traffic is present in the vicinity of the host vehicle 12, then it may be inferred that deceleration of target vehicles in the vicinity is caused by the traffic.

In response to the determination of operation 106 being negative, then a swarming metric is incremented, as illustrated at block 108. The swarming metric refers to a parameter indicative of a likelihood that swarming behavior is underway, e.g. expressed as a Bayesian probability. In an exemplary embodiment, the magnitude of the increment is based on the severity of the action of the object influencing motion, e.g. such that more sudden motion results in a larger increment than more gradual motion, and that coordinated behavior of multiple objects results in a larger increment than behavior of a single object.

In an exemplary embodiment, the swarming metric is configured to attenuate over time, such that as time passes without incidence of incrementing events results in the swarming metric reducing toward zero.

Control subsequently proceeds to operation 110. Likewise, in response to the determination of operation 106 being positive, or in response to the determination of operation 104 being negative, control proceeds to operation 110.

At operation 110, a determination is made of whether a change in vehicle state, consistent with an attack, is detected. As nonlimiting examples, a change in vehicle state includes an unexpected change in passenger weight, a window being broken, a rapid decrease in tire pressure indicating a blowout, or one or more sensors 26 being blocked. Such behavior indicates that a third party is attempting to damage or otherwise adversely affect the host vehicle 12.

In response to the determination of operation 110 being positive, i.e. a change in vehicle state is detected, a determination is made of whether the cause for the change in state can be determined, as illustrated at operation 112. This determination may be based on information relating to road conditions, including traffic, construction, or other conditions as discussed above. As an example, if snow or other adverse weather conditions are present in the vicinity of the host vehicle 12, then it may be inferred that blockage of a sensor is caused by the weather.

In response to the determination of operation 112 being negative, then the swarming metric is incremented, as illustrated at block 114. In an exemplary embodiment, the magnitude of the increment is based on the type of change in vehicle state, e.g. such that an unexpected change in passenger weight results in a larger increment than a blocked sensor, as the former behavior is more likely indicative of an attack while the latter may be benign.

Control subsequently proceeds to operation 116. Likewise, in response to the determination of operation 112 being positive, or in response to the determination of operation 110 being negative, control proceeds to operation 116.

A determination is made of whether the swarming metric exceeds a calibrated threshold, as illustrated at block 116. The threshold may be calibrated by a vehicle manufacturer to correspond to a high likelihood that a swarming attack is underway.

In response to the determination of operation 116 being negative, control returns to block 102. The algorithm thereby continues unless and until the swarming metric exceeds the threshold.

In response to the determination of operation 116 being positive, the vehicle is controlled in a swarm defense mode, as illustrated at block 118. The swarm defense mode refers to an alternate form of control in which the host vehicle 12 performs actions to counteract or mitigate a swarming attack. As an example, the swarm defense mode may comprise alerting police, other authorities, or other entities, e.g. via the wireless communications system 28. Such an alert may include both the presence of the swarming attack as well as images of any objects proximate the host vehicle 12, license plates of target vehicles proximate the host vehicle 12, or other information which may be relevant to the police or other entity. The swarm defense mode may also comprise controlling the vehicle to traverse any available escape path, even if such travel is on a restricted driving surface where travel would normally be disallowed, e.g. driving on a shoulder of a highway.

Variations on the above algorithm are, of course, possible. As an example, additional parameters may be considered to determine whether a swarming attack is underway, such as the presence or absence of emergency vehicles.

As may be seen, the present disclosure provides system and method for detecting swarm behavior proximate an autonomous vehicle, and to respond appropriately when such behavior is detected.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An automotive vehicle comprising:
at least one actuator configured to control vehicle steering, acceleration, braking, or shifting;
at least sensor configured to provide signals based on features in the vicinity of the vehicle; and
a controller configured to control the at least one actuator in an automated driving mode, the controller being configured to detect behavior of at least one object external to the vehicle based on signals from the at least one sensor, to determine, based on the detected behavior, that the at least one object is influencing lateral or longitudinal motion of the vehicle, to determine, based on signals from the at least one sensor, that no driving condition is present to necessitate the behavior of the at least one object, and to, in response to the determinations, activate a swarm defense mode.

2. The automotive vehicle of claim 1, wherein the at least one object external to the vehicle comprises one or more target vehicles proximate the vehicle.

3. The automotive vehicle of claim 1, wherein the swarm defense mode comprises communicating an alert to an external authority entity.

4. The automotive vehicle of claim 1, wherein the swarm defense mode comprises controlling the at least one actuator to drive the vehicle on a restricted driving surface.

5. The automotive vehicle of claim 1, wherein influencing lateral or longitudinal motion of the vehicle comprises bringing the vehicle to a full stop.

6. The automotive vehicle of claim 1, wherein the controller is further configured to detect a change in vehicle state based on signals from the at least one sensor, and to activate the swarm defense mode in further response to a detected change in vehicle state.

7. The automotive vehicle of claim 6, wherein the change in vehicle state comprises a change in passenger weight, a sensor being blocked, a window being broken, or a rapid decrease in tire pressure.

8. A method of controlling an automotive vehicle, comprising:
providing the vehicle with at least one actuator configured to control vehicle steering, acceleration, braking, or shifting, at least sensor configured to provide signals based on features in the vicinity of the vehicle, and a controller configured to control the at least one actuator in an automated driving mode;
detecting, via the controller, behavior of at least one object external to the vehicle based on signals from the at least one sensor;
determining, via the controller, based on the detected behavior, that the at least one object is influencing lateral or longitudinal motion of the vehicle;
determining, via the controller, based on signals from the at least one sensor, that no driving condition is present to necessitate the behavior of the at least one object; and
in response to the determining steps, automatically controlling the vehicle, via the controller, according to a swarm defense mode.

9. The method of claim 8, wherein the at least one object external to the vehicle comprises one or more target vehicles proximate the vehicle.

10. The method of claim 8, wherein automatically controlling the vehicle according to the swarm defense mode comprises communicating an alert to an external authority entity.

11. The method of claim 8, wherein automatically controlling the vehicle according to the swarm defense mode comprises automatically controlling the at least one actuator to drive the vehicle on a restricted driving surface.

12. The method of claim 8, wherein influencing lateral or longitudinal motion of the vehicle comprises bringing the vehicle to a full stop.

13. The method of claim 8, further comprising detecting, via the controller, a change in vehicle state based on signals from the at least one sensor, wherein the automatically controlling the vehicle according to the swarm defense mode is in further response to detecting the change in vehicle state.

14. The method of claim 13, wherein the change in vehicle state comprises a change in passenger weight, a sensor being blocked, a window being broken, or a rapid decrease in tire pressure.
